(19) United States
(12) Patent Application Publication
(10) Pub. No.: US 2006/0045978 A1
(43) Pub. Date: Mar. 2, 2006

(54) Non-toxic wood preservation

(76) Inventors: Wolf H. Hilbertz, Dubai (AE); Thomas J. Goreau, Cambridge, MA (US)

Correspondence Address: PARKHURST & WENDEL, L.L.P., 1421 PRINCE STREET, SUITE 210, ALEXANDRIA, VA, 22314-2805, US

(21) Appl. No.: 10/926,326

(22) Filed: Aug. 26, 2004

(51) Int. Cl. B05D 3/02

(52) U.S. Cl. 427/372.2

(57) ABSTRACT

A method for the protection of wood, increasing the strength and load-bearing capacity of wood, and increasing the capacity of wood to generate friction with adjacent soils, by treating wood with one or more minerals of low toxicity mixed with an aqueous medium, to provide wood that retains the infused minerals for an extended period of time while avoiding the detrimental environmental effects of conventional chromium or copper-based inorganic salt preservation and organic chemical methods.

The present invention relates to a mineral compound and its use in a method for preserving and protecting wood against decay and insect infestation, and fire, increasing the strength and load-bearing capacity of wood, and increasing the capacity of wood to generate friction with adjacent soils. The invention is useful in both hardwoods and softwoods.

On a commercial scale, the method of the present invention is preferably conducted using a treatment cylinder of a sufficient size to be both economically practical and convenient.

### BACKGROUND OF THE INVENTION

Preservation of wood materials with chemicals and mineral compounds has often posed a significant hazard to the environment. Various water-soluble salts, such as borax, copper and chromium salts, zinc chlorides, and sodium fluoride have been used to provide wood preservative properties. These salts offer protection against mold, fungi and insect infestation.

Unfortunately, wood treated with the types of water-soluble inorganic salts described above are susceptible to leaching of the salts into the surrounding environment, and the treated wood often becomes susceptible to microbial or insect attack over time as salt concentration decreases in the treated wood.

Chromated-copper-arsenic (CCA) compositions are used in the conventional treatment of wood products. CCA acts as a preservative and also protects the wood surface from softening when exposed to sun and rain. However, chromium and arsenic salts are highly toxic and any leaching action contaminates the surrounding environment. Accordingly, governmental agencies of various countries are regulating and/or prohibiting use of such materials.

The leaching of both water-soluble inorganic salts and CCA compositions commonly employed in the wood preservation industry shorten the economic life of the treated wood. The present invention seeks substantially to reduce leaching and to increase the economic life of the treated wood, thereby alleviating the world's demand for timber and slowing the rate of de-forestation.

Unlike water-soluble salts, organic chemicals used to treat wood do not tend to leach out of treated lumber to a significant extent, but these materials are generally toxic and are also increasingly subject to restrictions on use and disposal mandated by governmental agencies.

Preservation of wood to enhance its fire-resistant capacity is the subject of U.S. Pat. No. 4,612,050 to Hicks, which describes a process for preparation of a liquid solution of sodium silicate, mineral water, and citric or malic acid, which forms a gel within wood following application of the liquid solution as an exterior coating. This patent is based on a formulation and chemical reaction different from that made by means of this application and does not utilize pressure treatment to maximize mineral impregnation.

The present invention seeks to improve upon the prior art wood treatment methods by providing a treatment that is of low toxicity, is made up of highly stable minerals, reduces undesired viscosity and corrosion effects encountered in other wood preservative treatment processes, does not leach active ingredients out of impregnated wood materials significantly over time, improves strength, load-bearing capacity and friction capacity of wood, decreases combustibility and ignition temperature, and protects the treated wood from degradation by microorganisms, mold, fungi, insects, wood-boring marine organisms, and fire.

### STATEMENT OF INVENTION

The present invention relates to a method for treatment of wood by (a) contacting wood material with an aqueous treatment solution containing one or more minerals to provide impregnated wood material, and (b) separating the impregnated wood material from the aqueous treatment solution.

In a preferred embodiment, the present invention further provides for subjecting the impregnated wood material to a pressure treatment during step (a).

### DETAILED DESCRIPTION

As used herein, the following terms have the designated definitions, unless the context clearly indicates otherwise.

As used herein, the terms “wood” and “wood material” shall mean all forms of wood, for example, solid wood (such as timber or lumber in the form of logs, beams, plants, sheets and boards), wood composite materials (such as wood fiber board, chip board, and particle board) and all products made from wood and wood-composite materials (such as mill frames, decking, siding, truss joists, foundation piers, pilings, flooring, siding, cladding, roof shingles and utility poles).

As used herein, the term “water” shall mean one or more of seawater, saltwater, brines, brackish water, and fresh water.

As used herein, the term “microbicide” refers to a compound capable of inhibiting the growth of or controlling the growth of microorganisms at a locus; microbicides include, for example, bactericides, fungicides, and algaecides.

The mineral combinations of the present invention include one or more of the following: (a) 0.1% to 100% by weight limestone (CaCO₃); (b) 0.1% to 100% by weight dolomite (CaMg(CO₃)₂); (c) 0.1% to 100% by weight brucite (Mg(OH)₂); (d) 0.1% to 100% by weight calcium hydroxide, commonly called slaked lime (Ca(OH)₂); (e) 0.1% to 100% by weight Portland cement; (f) 0.1% to 100% by weight diatomaceous earth (Si(OH)₄), and (g) 0.1% to 100% by weight rock powder (including basalt and granite), where the weight percentages of the above components (a) through (g) are based on the ratio of (x) the weight of the component to (y) the total weight of all minerals applied to treat the wood.

The mineral combinations that are the subject of this invention may be incorporated into the wood material by treatment methods that involve contact of the wood with aqueous solutions, emulsions or suspensions of the aforementioned mineral combinations, either in combination or individually, added in any order. Suitable methods of contact include, for example, brushing, spraying, dipping, pressure and other similar treatments. With respect to wood material such as particle board or plywood, the mineral combinations may also be introduced in a glue-mixing process. Preferably, application of the mineral combinations to wood materials is by pressure treatment using a treatment cylinder of sufficient size to be both economically practical and convenient, using two or more atmospheres of pressure.

Impregnation of the mineral combinations into the wood material may be accomplished by use of an aqueous carrier solution. Preferably, the agent solution is an aqueous solution of one or more of saltwater, seawater, brines, brackish water, and freshwater.

The soaking of wood and other materials can be done at standard pressure, by use of vacuum-pressure cycles, pressure or other standard wood preservation processes. Use of vacuum-pressure or pressure techniques reduces treatment time and increases the level of penetration of the mineral into the wood product, thereby increasing the effectiveness of the preservative treatment. Preferably the treatment is conducted by subjecting the impregnated wood material to a pressure treatment during contact of the wood material with the aqueous treatment solution for a sufficient time, preferably from about 5 minutes to about 72 hours.

For the aqueous mineral agent solutions, the concentration of the mineral combination in the water varies. Choice of mineral concentration may depend on a variety of factors, including the species, size, type, form and other characteristics of the wood to be treated as well as the intended end use of the treated material and the solubility of the minerals used.

Optional treatments include addition of one or more of the following adjuvants during the treatment process: surfactants, acids, bases, dispersants, defoamers, corrosion inhibitors, wax, water-repellent polymer agents, and fire retardants (such as phosphoric acid salts, sulfuric acid salts, carbonates, borates, nitrates, chlorides, and bromides.)

For some applications, additional optional ingredients may be included in the method of the present invention. For example one or more microbicides and pesticidal agents may be added to the treatment solutions used in the method of the present invention, thereby providing additional advantages and effectiveness. When treatment solutions containing microbicides (such as algicides, bactericides, fungicides and marine antifouling agents) or pesticides (such as insecticides) are employed, the proportions that are used will depend upon the relative efficacy of compounds in the mixture with respect to the amount of wood material to be treated and the targeted condition or pests to be controlled.

### EXAMPLES

Some embodiments of the invention are described in detail in the following Examples. Reference to “weight” in the Examples refers to the percentage of the weight of all substances (including water) applied to the wood. The Examples illustrate the invention.

### Example 1

There is formed a mixture of
3.5% by weight of limestone,
3.0% by weight of brucite,
1.0% by weight of calcium hydroxide, and
92.5% by weight of water.

### Example 2

There is formed a mixture of
60% by weight of Portland cement,
10% by weight of diatomaceous earth, and
30% by weight of water.

### Example 3

There is formed of a mixture of
40% by weight of dolomite,
10% by weight of brucite,
5% by weight of calcium hydroxide, and
45% by weight of seawater, brine, or fresh water.

### Example 4

There is formed a mixture of
40% by weight of diatomaceous earth,
15% by weight of brucite,
3% by weight of calcium hydroxide,
3% by weight of dolomite, and
39% by weight of water.

### Example 5

There is formed a mixture of
7.5% by weight of Portland cement,
0.5% by weight of brucite, and
92% by weight of water.

The mixtures in the above examples, applied using pressure for a period of from about 5 minutes to 72 hours at a temperature of from about 40° F. to about 250° F., will impregnate wood with the indicated components to make the treated wood: (i) a less desirable food for mold, fungi, bacteria, other microorganisms, wood-boring marine organisms, and insects, (ii) more resistant to fire, by reason of a reduced combustibility and a raised ignition temperature, (iii) stronger and of a higher load-bearing capacity, and (iv) more desirable to use in friction pile foundations, as the exterior surface of the treated wood will generate greater friction with adjacent soils. As to Examples 1 and 3 to 5, when the treated wood is placed in calcareous soil, the brucite will chemically react with the soil to form limestone, to create even more friction.

What is claimed is:

1. A method of treatment of wood to protect against fungi, mold, bacteria, insects, wood-boring marine organisms and fire, increase the strength and load-bearing capacity of the wood, and increase the capacity of the wood to generate friction with adjacent soils, comprising treating the wood with an effective amount of a combination of minerals containing as essential components one or more of the following: (a) 0.1% to 100% by weight limestone (CaCO₃); (b) 0.1% to 100% by weight dolomite (CaMg(CO₃)₂); (c) 0.1% to 100% by weight brucite (Mg(OH)₂); (d) 0.1% to 100% by weight calcium hydroxide, commonly called slaked lime (Ca(OH)₂); (e) 0.1% to 100% by weight Portland cement; (f) 0.1% to 100% by weight diatomaceous earth (Si(OH)₄), and (g) 0.1% to 100% by weight rock powder (including basalt and granite), where the weight percentages of the above components (a) through (g) are based on the ratio of (x) the weight of the component to (y) the total weight of all minerals applied to treat the wood, wherein the combination of minerals is applied in a water-diluted form.

2. The method of claim 1 wherein the wood is solid softwood.

3. The method of claim 2, wherein the solid softwood is southern yellow pine or Douglas fir.

4. The method of claim 1 wherein the wood is a solid hardwood.

5. The method of claim 1 wherein the wood is a processed material such as plywood or particle board.

6. The method of claim 1 wherein the combination of minerals in water-diluted form comprises 3.5% by weight of limestone, 3.0% by weight of brucite, 1.0% by weight of calcium hydroxide, and 92.5% by weight of water.

7. The method of claim 1 wherein the combination of minerals in water-diluted form comprises 60% by weight of Portland cement, 10% by weight of diatomaceous earth, and 30% by weight of water.

8. The method of claim 1 wherein the combination of minerals in water-diluted form comprises 40% by weight of dolomite, 10% by weight of brucite, 5% by weight of calcium hydroxide, and 45% by weight of seawater.

9. The method of claim 1 wherein the combination of mineral in water-diluted form comprises 40% by weight of diatomaceous earth, 15% by weight of brucite, 3% by weight of calcium hydroxide, 3% by weight of dolomite, and 39% by weight of water.

10. The method of claim 1 wherein the combination of minerals in water-diluted form comprises 7.5% by weight of Portland cement, 0.5% by weight of brucite, and 92% by weight of water.

11. A method for treatment of wood to protect against mold, fungi, bacteria, insects, wood-boring marine organisms, and fire, increase strength and load-bearing capacity, and increase the capacity to generate friction with adjacent soils, comprising the steps of:
a. charging one or more pieces of wood to a treatment vessel;
b. closing the vessel;
c. charging the vessel with an effective amount of one or more of the minerals (a) 0.1% to 100% by weight limestone (CaCO₃); (b) 0.1% to 100% by weight dolomite (CaMg(CO₃)₂); (C) 0.1% to 100% by weight brucite (Mg(OH)₂); (d) 0.1% to 100% by weight calcium hydroxide, commonly called slaked lime (Ca(OH)₂); (e) 0.1% to 100% by weight Portland cement; (f) 0.1% to 100% by weight diatomaceous earth (Si(OH)₄), and (g) 0.1% to 100% by weight rock powder (including basalt and granite), where the weight percentages of the above components (a) through (g) are based on the ratio of (x) the weight of the component to (y) the total weight of all minerals applied to treat the wood, wherein such minerals are applied in a water-diluted form;
d. pressuring the treatment vessel;
e. evacuating the vessel; and
f. drying the impregnated wood.
